(19) United States
(12) Patent Application Publication
(10) Pub. No.: US 2002/0178155 A1
(43) Pub. Date: Nov. 28, 2002

(54) Data analyzer apparatus and data analytical method

(76) Inventor: Shigeaki Sakurai, Tokyo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 10/151,965

(22) Filed: May 22, 2002

(30) Foreign Application Priority Data
May 25, 2001 (JP) 2001-157198

(51) Int. Cl. G06F 17/30

(52) U.S. Cl. 707/3

(57) ABSTRACT

A data analyzer apparatus comprises a document storage device storing a set of documents containing attributes representing text data and time data, a key concept dictionary storage device storing a key concept dictionary, a selector selecting a subset of documents from the set of documents in accordance with a given combination of the attributes, a first extraction device extracting a set of key concepts from each document belonging to the subset selected, based on the key concept dictionary, a second extraction device extracting the time data from each document belonging to the subset selected, and a concept sequence generator generating concept sequence including key concepts extracted from each document belonging to the subset using the time data.

### CROSS-REFERENCE TO RELATED APPLICATIONS

This application is based upon and claims the benefit of priority from the prior Japanese Patent Application No. 2001-157198, filed May 25, 2001, the entire contents of which are incorporated herein by reference.

### BACKGROUND OF THE INVENTION

1. Field of the Invention

The present invention relates to a data analyzer apparatus and data analytical method which analyze a document containing text data and time data.

2. Description of the Related Art

With advances in the techniques of storing data in electronic media, it is increasingly necessary to efficiently extract necessary information from a large amount of stored data.

According to a system for notifying acquired rules disclosed in Jpn. Pat. Appln. KOKAI Publication No. 2001-22776 (to be referred to as reference 1 hereinafter), when data stored in a database is provided as an input at a given time point, a regularity existing in the data is found, and another regularity is also found at another time point. By comparing these regularities, the transition of regularity over time is presented.

According to the technique disclosed in special issue on the IJCAI'99 affiliate event Networks'99 “Network modeling of a human-computer interaction task based on a self-organization method” by S. Sakurai and et al. (to be referred to as reference 2 hereinafter), by collecting many data including word sequences and words representing their responses, the relationship between the word sequences and the words representing their responses can be formed into a network structure model. In addition, by using the model, a word representing a response corresponding to a newly provided word sequence can be predicted.

According to the data processing apparatus disclosed in Jpn. Pat. Appln. KOKAI Publication No. 11-126198, time-series data is supplied to the apparatus to be divided into units each having a meaning, and a model can be learnt for each set of units having a similar meaning. By using this model, the next result corresponding to newly supplied time-series data can be predicted.

The conventional technique disclosed in reference 1 is designed to only present a user with a changed rule, but cannot predict a phenomenon that will occur over time. According to the conventional technique disclosed in reference 2, no method is disclosed for acquiring a time sequence as a kind of time-series data. It is therefore necessary to design a method of generating a word sequence in accordance with a problem. In the conventional technique disclosed in reference 3, a model to be learnt is formed on the basis of a pattern, a user cannot intuitively understand the meaning of the model, and no explicit meaning is given to time-series data. This makes it impossible to give any meaning to a prediction result.

### BRIEF SUMMARY OF THE INVENTION

It is an object of the present invention to provide a data analyzer apparatus and data analytical method which can generate a word (concept) sequence model serving as the basis for modeling regularity in accordance with a stored set of documents containing text data and time data.

According to an aspect of the invention, there is provided a data analyzer apparatus comprising: a document storage device configured to store a set of documents containing plural attributes representing at least text data and time data; a key concept dictionary storage device configured to store a key concept dictionary including representative words or phrases that are likely to be described in the text data; a selector configured to select a subset including plural documents associated with each other from the set of documents stored in the document storage device in accordance with a given combination of the attributes; a first extraction device configured to extract a set of key concepts from each of plural documents belonging to the subset selected, based on the key concept dictionary; a second extraction device configured to extract the time data from each of the plural documents belonging to the subset selected; and a concept sequence generator configured to generate concept sequence including key concepts extracted from each of the documents belonging to the subset using the time data included in each of the documents.

According to another aspect of the invention, there is provided a data analysis method comprising: storing a set of documents containing plural attributes representing at least text data and time data in a document storage device; storing a key concept dictionary including representative words or phrases that are likely to be described in the text data in a key concept dictionary storage device; selecting a subset including plural documents associated with each other from the set of documents stored in the document storage device in accordance with a given combination of the attributes; extracting a set of key concepts from each of plural documents belonging to the subset elected, based on the key concept dictionary; extracting the time data from each of the plural documents belonging to the subset selected; and generating concept sequence including key concepts extracted from each of the documents belonging to the subset using the time data included in each of the documents.

### BRIEF DESCRIPTION OF THE SEVERAL VIEWS OF THE DRAWING

FIG. 1 is a block diagram showing an arrangement of a sequence text data analyzer apparatus according to an embodiment of the present invention;

FIG. 2 is a flow chart showing a procedure in the sequence text data analyzer apparatus according to this embodiment;

FIG. 3 is a view showing documents stored in a document storage device;

FIG. 4 is a view showing a document subset associated with company C1 and Mr. M1 and extracted from the document set stored in the document storage device;

FIG. 5 is a view showing a document subset associated with company C2 and Mr. M2 and extracted from the document set stored in the document storage device;

FIG. 6 is a view showing a document subset associated with company C3 and Mr. M1 and extracted from the document set stored in the document storage device;

FIG. 7 is a view showing a document subset associated with company C4 and Mr. M2 and extracted from the document set stored in the document storage device;

FIG. 8 is a view showing a result obtained by lexical analysis on the text of each document included in the document subset in FIG. 4;

FIG. 9 is a view showing a key concept dictionary stored in a key concept dictionary storage device;

FIG. 10 is a view showing a characteristic value set generated by applying the lexical analysis result in FIG. 8 to the key concept definition dictionary in FIG. 9;

FIG. 11 is a view showing combinations of time-series data and classes which are generated with respect to the documents stored in the document storage device;

FIG. 12 is a view showing a self-organized model;

FIG. 13 is a block diagram showing another arrangement of the sequence text data analyzer apparatus according to this embodiment;

FIG. 14 is a flow chart showing a procedure for predicting a result from a series of new documents on the basis of the model self-organized by the sequence text data analyzer apparatus according to this embodiment;

FIG. 15 is a view showing associated documents which are estimation objects; and

FIG. 16 is a view showing an example of time-series data generated from the associated documents in FIG. 15.

### DETAILED DESCRIPTION OF THE INVENTION

The embodiments of the present invention will be described below with reference to the views of the accompanying drawing.

(First Embodiment)

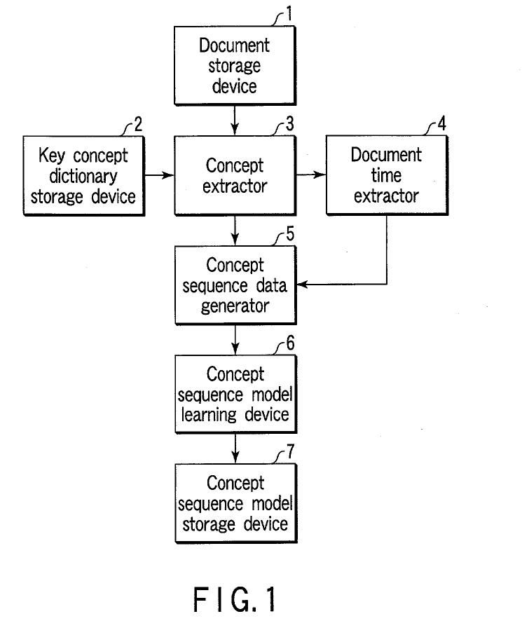

FIG. 1 shows an arrangement of a sequence text data analyzer apparatus according to the first embodiment of the present invention. As shown in FIG. 1, the sequence text data analyzer apparatus includes a document storage device 1, concept extractor 3, concept sequence generator 5, concept sequence model learning device 6, and concept sequence model storage device 7 which are sequentially coupled to each other. A key concept dictionary storage device 2 and document time extractor 4 are respectively connected to the input and output ports of the concept extractor 3. The output port of the document time extractor 4 is connected to the concept sequence generator 5.

This sequence text data analyzer apparatus can be implemented by software. More specifically, the processing performed by the sequence text data analyzer apparatus can be implemented by causing a computer to execute the programs stored in a recording medium. In this case, part or all of the software can be incorporated as a chip or board in the computer. When this sequence text data analyzer apparatus is to be implemented by software, the apparatus can be incorporated as one function of another software in system software. Alternatively, the sequence text data analyzer apparatus can be implemented as dedicated purpose hardware.

Each of the document storage device 1, key concept dictionary storage device 2, and concept sequence model storage device 7 is constructed by a storage device such as a hard disk, optical disk, or semiconductor memory. Note that the respective storage devices may be of different types or all or some of them may be of the same type.

Although not shown in FIG. 1, the sequence text data analyzer apparatus includes an input/output device that exchanges data with external devices. Obviously, the sequence text data analyzer apparatus may include a GUI (Graphical User Interface) or network connection interface.

Each document stored in the document storage device 1 contains text data, time data, and one or more attributes. More specifically, in the document storage device 1 are stored a series of temporal transitional texts describing the business activities of salesperson and merchandise sales trends in retailing operation, a series of temporal transitional texts describing various inquiries from customers and answer contents in help desk operation, and the like. These data can be applied to various fields and purposes.

The processing performed by the sequence text data analyzer apparatus according to the first embodiment will be described below.

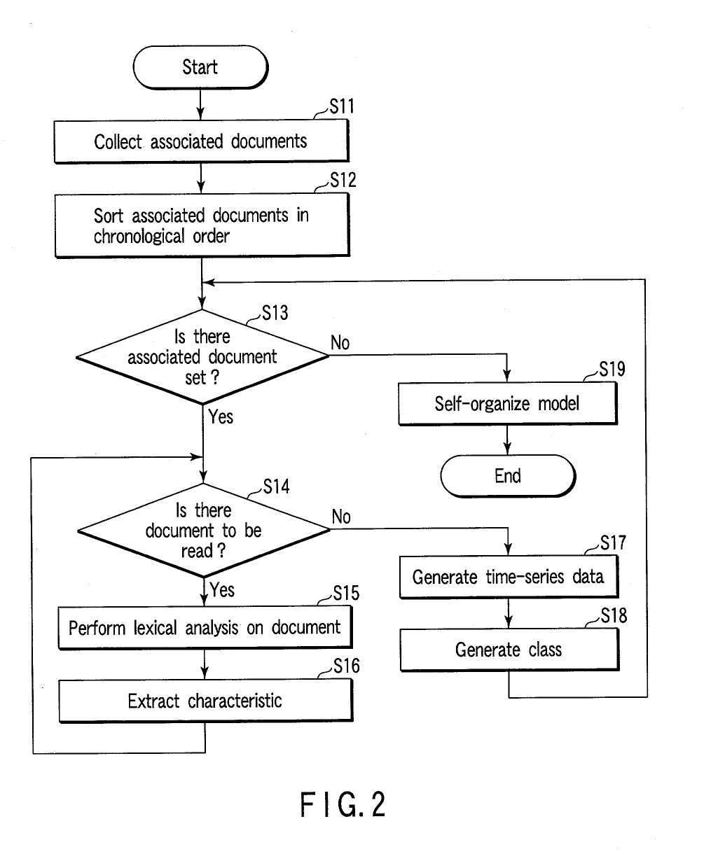

FIG. 2 shows an example of the procedure executed by this sequence text data analyzer apparatus.

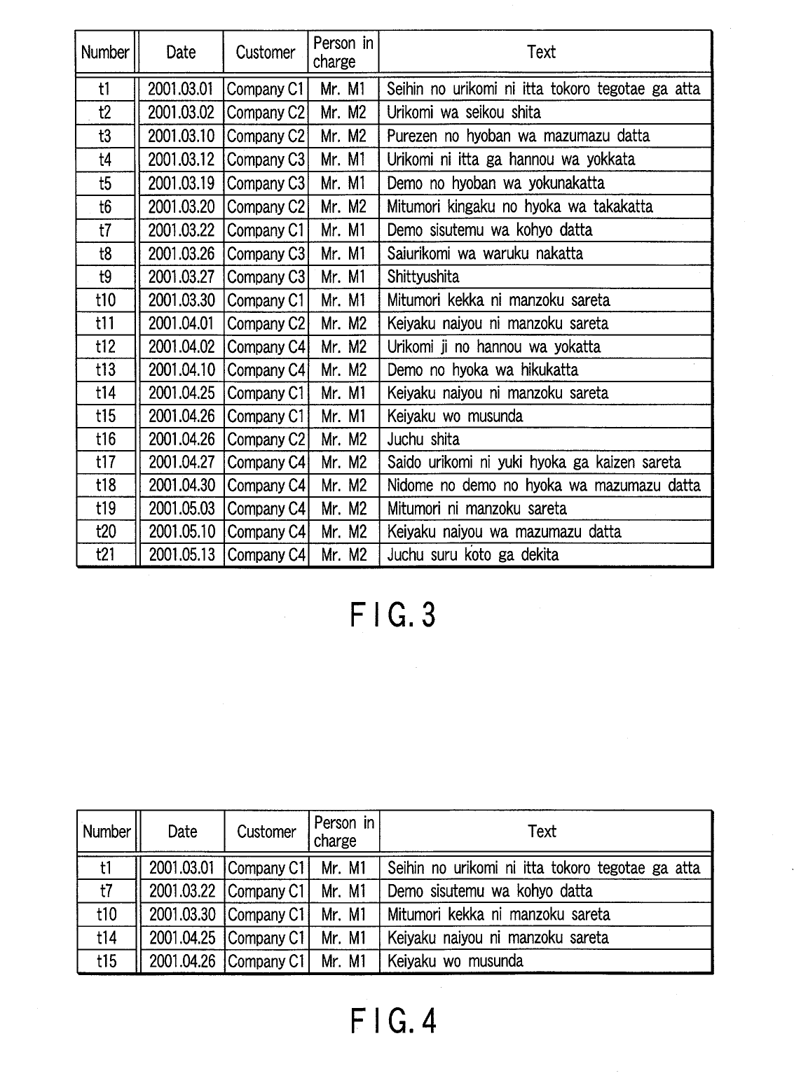

Assume that a set of a plurality of documents describing a plurality of items (attributes), i.e., “number”, “date”, “customer”, “person in charge”, and “text”, are stored in the document storage device 1, as shown in FIG. 3. Numbers t1 to t21 are the serial numbers of the documents.

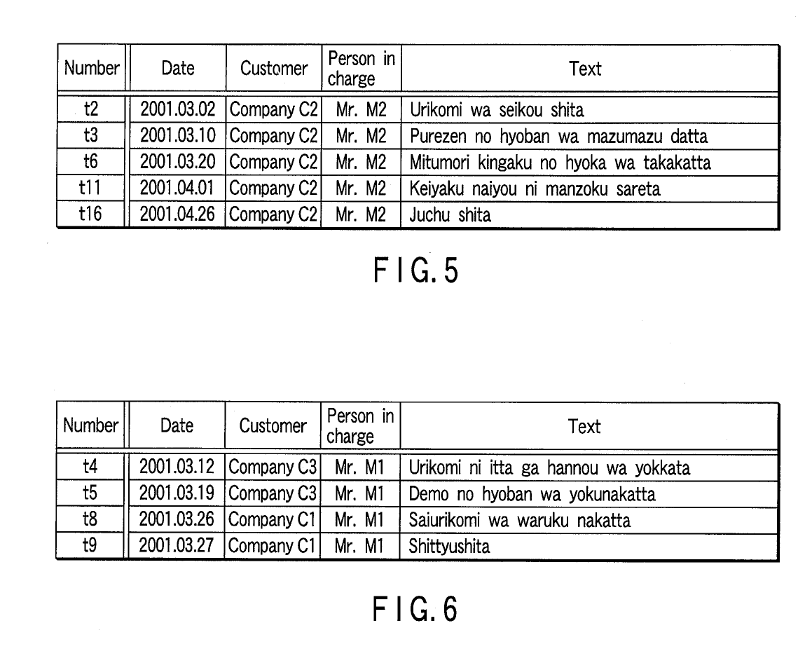

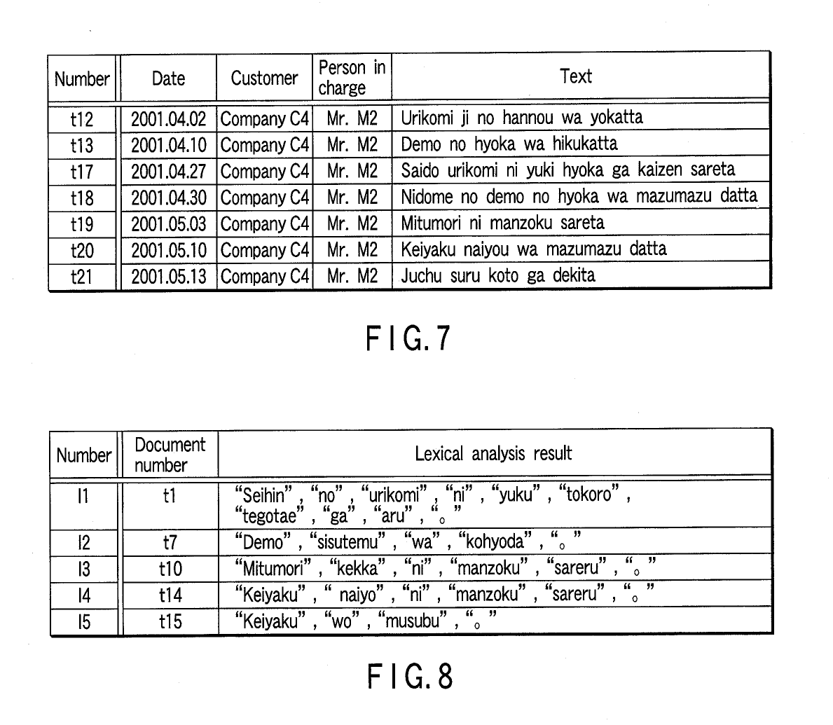

In step S11, the documents stored in the document storage device 1 are passed to the concept extractor 3, which in turn generates document subsets including associated documents on the basis of a predetermined combination of items attached to the documents. If, for example, a combination of “customer” and “person in charge” is selected as a predetermined combination of document items, sets of associated documents in which combinations of “customer” and “person in charge” coincide witch each other, are acquired. In this case, the four types of document subsets shown in FIGS. 4 to 7 are produced from the document set in FIG. 3. Document sets may be acquired on the basis of a combination of a single “customer” and a plurality of “persons in charge”, a combination of a plurality of “customers” and a single “person in charge”, or a combination of a plurality of “customers” and a plurality of “persons in charge”.

Note that, for example, such keys for classifying documents may be designated externally. Alternatively, associated documents may be acquired by using the clustering technique. Various other alterative methods are conceivable.

In step S12, the concept extractor 3 sorts the documents in chronological order in each document subset obtained in step S11, referring to the time data attached to each document belonging to the corresponding document subset. In the case shown in FIG. 3, the concept extractor 3 sorts the documents in chronological order referring to the date data belonging to the item name “date”, e.g., the date (year/month/day/hour/minute) when each document was generated or the date (year/month/day/hour/minute) associated with the text of each document. In the cases shown in FIGS. 4 to 7, since the documents have already been sorted in chronological order, the storage locations of the documents do not change upon sorting.

In step S13, the concept extractor 3 extracts one of the document subsets. If there is no document subset to be extracted, the flow advances to step S19. If there is a document subset to be extracted, the flow advances to step S14. Assume that the document subset shown in FIG. 4 is extracted.

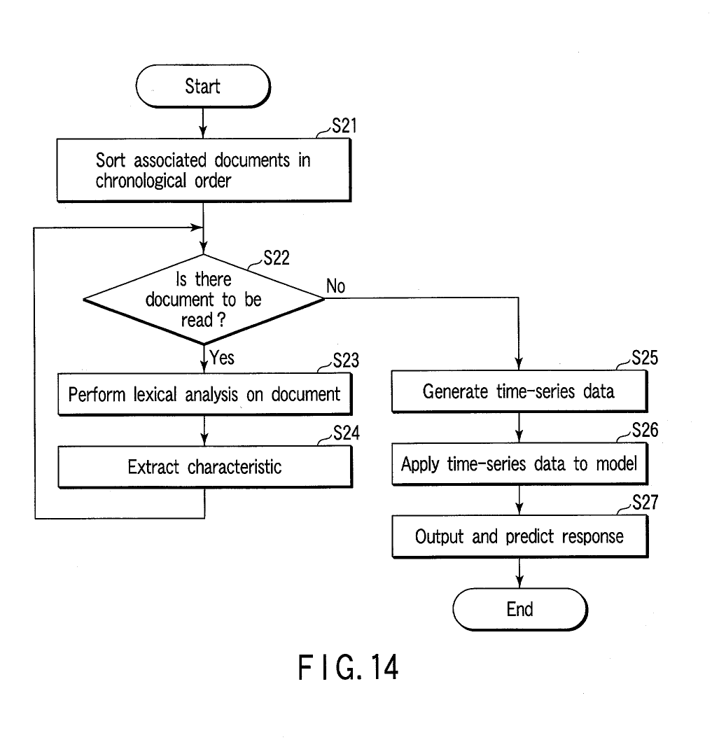

In step S14, the concept extractor 3 sequentially extracts the documents one by one from the extracted document subset (FIG. 14) from the uppermost document (i.e., in chronological order). If there is no document to be extracted, the flow advances to step S17. If there is a document to be extracted, the flow advances to step S15. Assume that the first document t1 is extracted from the document subset in FIG. 4.

In step S15, the concept extractor 3 divides the document extracted in step S14 into lexicons, using lexical analysis. Number l1 in FIG. 8 indicates an example of this result (note that numbers l1 to l5 are the serial numbers of the lexical analysis results on the respective documents). For example, by executing lexical analysis on the contents of the item “text” (i.e., “Seihin no urikomi ni itta tokoro tegotae ga atta”) of the first document t1 of the document subset in FIG. 4, the lexicon set indicated by number l1 in FIG. 8 (i.e., “(seihin)”, “(no)”, (“urikomi”), (“ni”), (“iku”), (“tokoro”), (“tegotae”), (“ga”), (“aru”), and “∘”) is obtained.

In step S16, the concept extractor 3 extracts a characteristic corresponding to the document by using the key concept dictionary stored in the key concept dictionary storage device 2 and the lexical analysis result obtained in step S15, and assigns it to the document.

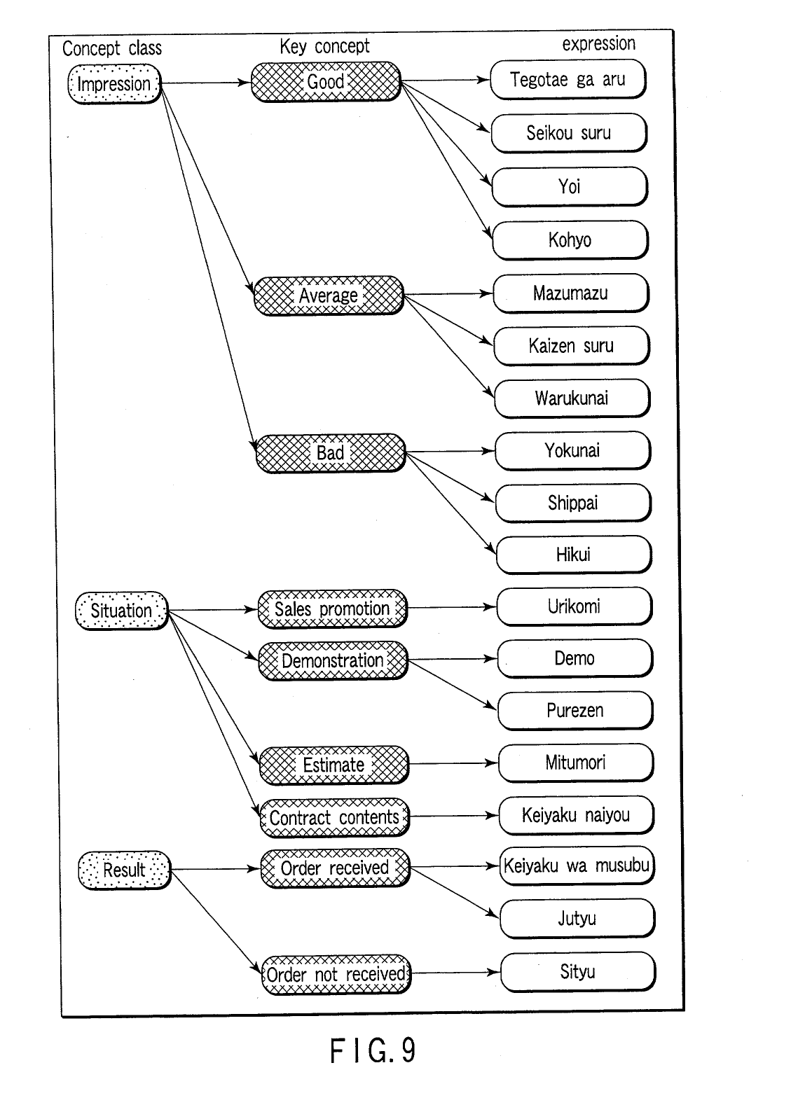

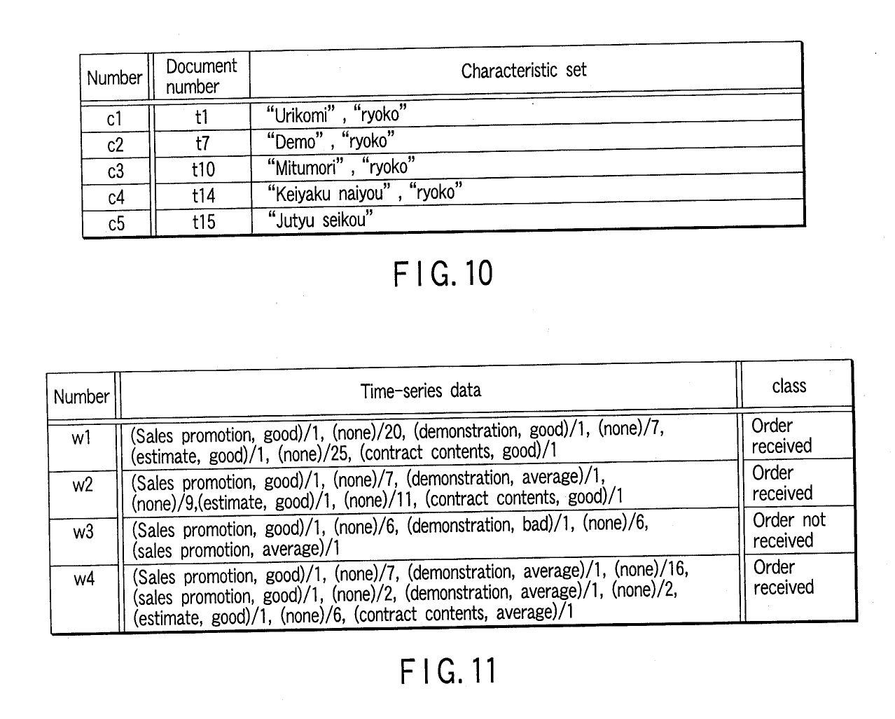

Consider a case wherein a characteristic is obtained on the basis of the lexicon set indicated by number 11 in FIG. 8, assuming that the key concept dictionary shown in FIG. 9 is stored in the key concept dictionary storage device 2. In this case, since concept class “situation”, key concept “sales promotion”, and expression “urikomi” coincide with “urikomi” of the lexicon set, characteristic “sales promotion” is extracted. In addition, since concept class “impression”, key concept “good”, and expression “tegotae ga aru” coincide with “tegotae”, “ga”, and “aru” of the lexicon set, characteristic “good” is extracted. FIG. 10 shows an example of this result (note that c1 to c5 are the serial numbers of characteristic sets generated with respect to the documents).

The above processing is repeated to process the remaining documents (l1 to l5 in FIG. 8 and c2 to c5 in FIG. 10) in FIG. 4 in the same manner.

When characteristics are extracted from all the documents belonging to one document subset, the flow advances from step S14 to step S17. In step S17, the concept sequence generator 5 generates time-series data by using the characteristic set generated with respect to the single document subset except for the last document in chronological order and “time” assigned to each document. Note that “time” assigned to each document is provided by the document time extractor 4.

Assume that time-series data is generated with reference to a given day. For example, assume that the characteristic value set shown in FIG. 10 is generated with respect to the respective documents of the document subset in FIG. 4. In this case, time-series data is generated with respect to the characteristic values except for the last characteristic value set (c5). More specifically, with reference to the time of the first document, a characteristic value set is assigned to a day when a characteristic value is given, and data indicating that no characteristic value is given (e.g., “none”) is assigned to a day when no characteristic value is given, thereby generating time-series data. In this case, the time-series data corresponding to number w1 in FIG. 11 is generated for the document subset in FIG. 4. Referring to FIG. 11, w1 to w4 are the serial numbers of training examples each including time-series data and a class. In this time-series data, the numerical value written after each characteristic value, e.g., 1 of “(sales promotion, good)/1”, represents the number of times the characteristic value repeats.

In step S18, the concept sequence generator 5 generates a class corresponding to the time-series data generated in step S17 by using the chronologically last document in the document subset. Note that “time” assigned to each document is provided by the document time extractor 4. For example, in the characteristic value set in FIG. 10 that is generated from the document subset in FIG. 4, since the characteristic value indicated by number c5 is the last characteristic value, “order received” is the class. In this case, a class corresponding to number w1 in FIG. 11 is generated.

Note that when the same procedure as described above is executed for the document subsets shown in FIGS. 5 to 7 and the processing loop is terminated in step S13, the combinations of time-series data and classes shown in FIG. 11 are completed. Referring to FIG. 11, the combinations of time-series data and classes indicated by numbers w2 to w4 correspond to FIGS. 5 to 7.

In the above procedure example, in generating time-series data and classes, a class is generated from the chronologically last document. However, the user may designate classes for a chronological series of documents. In such a case, time-series data may also be generated for the last document.

In step S19, the concept sequence model learning device 6 performs self-organization of a model on the basis of combinations of time-series data and classes like those shown in FIG. 11. Upon completion of self-organization of a model, the resultant model is stored in the concept sequence model storage device 7, and the modeling processing is terminated.

As a technique of self-organization of a model, the self-organization method of extended object automaton disclosed in reference 2 can be used. This technique is a method of self-organizing a model by using both two types of background knowledge and six basic rules. A model having a network structure can be self-organized by applying this technique to data including time-series data and corresponding classes.

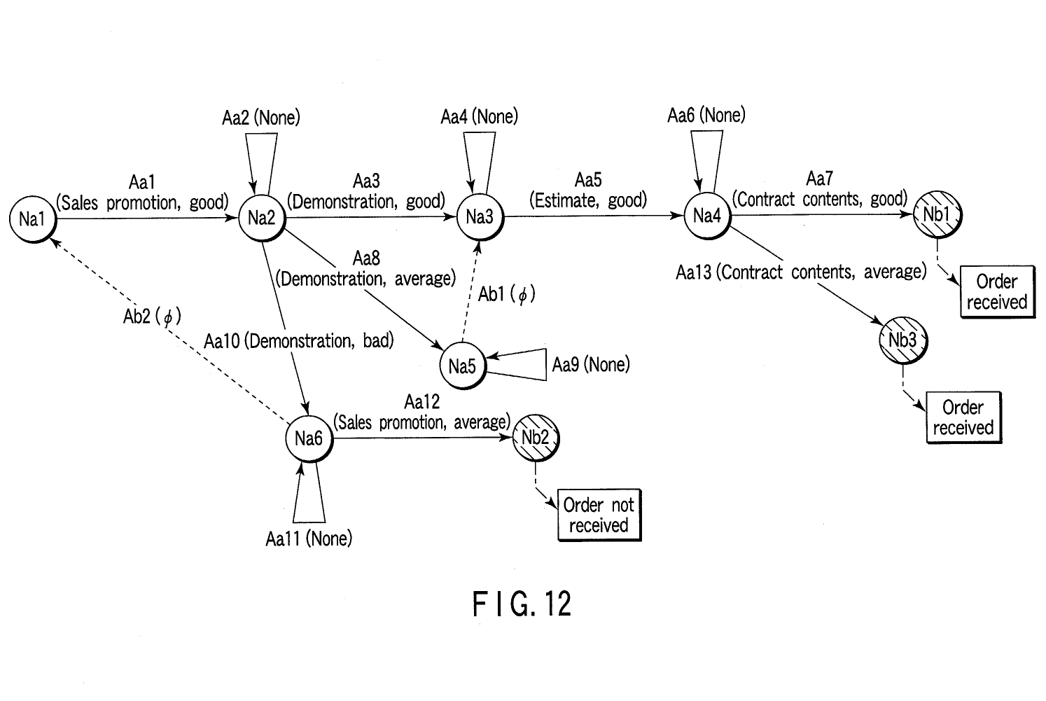

If, for example, the four types of combinations of time-series data and classes in FIG. 11 are sequentially given, the model shown in FIG. 12 can be obtained. Referring to FIG. 12, Aa1 to Aa13 are the numbers indicating normal arcs (each storing a plurality of words which are similar in meaning) configuring the model stored in the concept sequence model storage device 7. Ab1 to Ab2 are the numbers indicating null transition arcs (which store no word) configuring the model stored in the concept sequence model storage device 7. Na1 to Na6 are the numbers indicating intermediate nodes (which allow a plurality of arcs to be input and output) configuring the model stored in the concept sequence model storage device 7. Nb1 to Nb3 are the numbers indicating terminal nodes (which allow a plurality of arcs to be input and responses corresponding to word sequences to be stored) configuring the model stored in the concept sequence model storage device 7.

The self-organization method of extended object automaton disclosed in the above reference will be briefly described below (which is described in detail in the reference 2).

The extended object automaton is a knowledge expression having a network expression and configured by directed arcs and nodes. There are two types of directed arcs called a normal arc and null transition arc. A normal ark stores a plurality of words that are similar in meaning, whereas a null transition arc stores no words. In addition, one unit time elapses when processing is done through a normal arc, whereas no time elapses when processing is done through a null transition arc. In this case, one unit time corresponds to input of one word in a word sequence. By using such null transition arcs, a plurality of types of continuous noise components existing in a word sequence can be expressed.

There are two types of nodes called an intermediate node and terminal node. The intermediate node allows a plurality of arcs to be input and output. The terminal node allows a plurality of arcs to be input and responses corresponding to a word sequence. If many arcs exist between such nodes, many word combinations can be expressed. If, however, a plurality of arcs in the same direction exist between nodes, it becomes unclear which arc was used, resulting in difficulty in identifying a word sequence. As a result, it becomes difficult to infer an appropriate response to a word sequence. Therefore, only one arc is set for each type of arc, at most, with respect to the same direction between arbitrary nodes.

According to this technique, a model is self-organized by using both two types of background knowledge and six basic rules.

The six basic rules will be briefly described first.

(1) Rule for using an arc: If the same word as an input word is assigned to a normal arc having a node corresponding to the current state as a start point, and the type of word is identical to the type of node serving as the end point of the arc, the state is shifted to the node serving as the end point by using the arc.

(2) Rule for using a null transition arc: If the same word as an input word is assigned to a normal arc having a node as a start point which serves as the end point of a null transition arc having a node corresponding to the current state as a start point, and the type of word is identical to the type of node reached, the state is shifted to the node serving as the end point of the normal arc by using these arcs.

(3) Rule for generating a self-loop: If two continuous words which do not exist at the terminal are the same, and a self-loop can be generated at a node corresponding to the current state, a normal arc having the node as start and end points is generated, and one word is assigned to the arc. In this case, the state is not shifted.

(4) Rule for using a front arc: If the type of node serving as the end point of an arc to which the same word as the word next to the current word coincides with the type of next word, and a normal arc can be generated at a node serving as the start point of the arc from the current node, an arc is generated between the current node and the node serving as the start point of the arc, and the current word is assigned to the generated arc. The state is then shifted to the node serving as the end point of the arc.

(5) Rule for generating a null transition arc: If the type of node serving as the end point of an arc to which the same word as the current word is assigned coincides with the type of the word, and a null transition arc can be generated at a node serving as the start point of the arc from the current node, a null transition arc is generated between the current node and the node serving as the start point of the arc, and the state is shifted to the node serving as the end point of the arc.

(6) Rule for generating a new node: A new node is generated, and a normal arc to which the current word is assigned is generated between the current node and the new node. The state is then shifted to the generated node.

The two types of background knowledge will be briefly described next.

(1) Identical words knowledge: In order to acquire a compact network expression while holding word sequence identification ability, words to be assigned to the same arc need to be limited. A combination of words that can be assigned to the same arc is described as identical words knowledge. Since a word set adjacent to such a word can be expected to be a similar word set, a compact network expression can be acquired while word sequence identification ability is held. In addition, since a combination of words can be expressed without inputting all combinations of words adjacent to an identical word, a network expression can be self-organized from fewer word sequences and their responses.

(2) Sequence changeable words knowledge: Assume that the order of words is exchanged. In this case, even if a word sequence exhibiting the same response is generated, a corresponding network expression cannot be self-organized by only applying basic rules unless all combinations of word orders are input. If, however, similar word sequences corresponding to the same response have to be input separately, many word sequences must be input. If, therefore, words to which the same response is obtained even when the order of words is exchanged are described as exchangeable words, and a combination of changeable words appears within a word sequence, a network expression that expresses not only the supplied word order but also the exchanged word order is self-organized. In this case, if a normal arc storing exchangeable words exists in the existing network expression, self-organization is performed by using the arc as much as possible.

A self-organization flow will be briefly described next.

A network expression is self-organized from a word sequence and its response by using the above six basic rules and two types of background knowledge according to the following procedure.

Step 1: A word sequence is input.

Step 2: The next word is extracted from the word sequence and set as the current word. If no word can be extracted, the current node is set as a terminal node, and the word sequence and its response are assigned to the node, thereby terminating self-organization.

Step 3: If the current word has already been used by the rule for using a front arc that is applied immediately before, the flow advances to step 6. If the current word has already been used by the rule for generating a self-loop that is applied immediately before, the flow returns to step 2.

Step 4: The basic rules are evaluated in consideration of identical words knowledge.

Step 5: The highest-order basic rule of the rules that satisfy the conditions is executed.

Step 6: One of the preceding words of the word sequence is extracted.

Step 7: If there is no word to be extracted, the flow returns to step 2.

Step 8: If no sequence changeability is established between the extracted word and the current word, the flow returns to step 6.

Step 9: Self-organization is performed between the extracted word and the current word according to the sequence changeable words knowledge, and the flow returns to step 6.

In the above procedure, the identical words knowledge is applied to basic rule determination to determine whether words are identical to each other instead of determining whether the words coincide with each other. In addition, with respect to the first word of a word sequence, a node serving as a start point must be simultaneously determined. If, therefore, the basic rule associated with null transition is established, the rule for using an arc is always established. Consequently, there is no need to determine the basic rule associated with null transition with respect to the first word. With regard to the sequence changeable words knowledge, all combinations of words appearing in a word sequence must be examined. Therefore, it is determined whether sequence changeability is established between the current word and all the preceding words. If the sequence changeability is established, corresponding self-organization is performed.

The self-organization method of extended object automaton has been briefly described above.

(Second Embodiment)

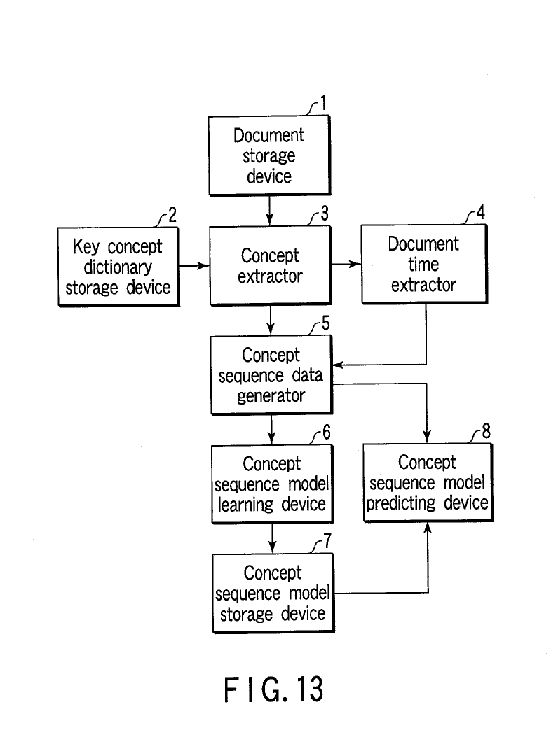

FIG. 13 shows an arrangement of a sequence text data analyzer apparatus according to the second embodiment of the present invention. As shown in FIG. 13, this sequence text data analyzer apparatus includes a document storage device 1, key concept dictionary storage device 2, concept extractor 3, document time extractor 4, concept sequence generator 5, concept sequence model learning device 6, concept sequence model storage device 7, and concept sequence predicting device 8.

In addition to the arrangement of the first embodiment, this sequence text data analyzer apparatus has the concept sequence predicting device 8 for performing, for example, processing of predicting a situation that will occur with respect to a new document sequence.

In this embodiment, a portion having a function of self-organizing a model is the same as that in the first embodiment, an additional portion having a function of performing processing for prediction according to the second embodiment will be described.

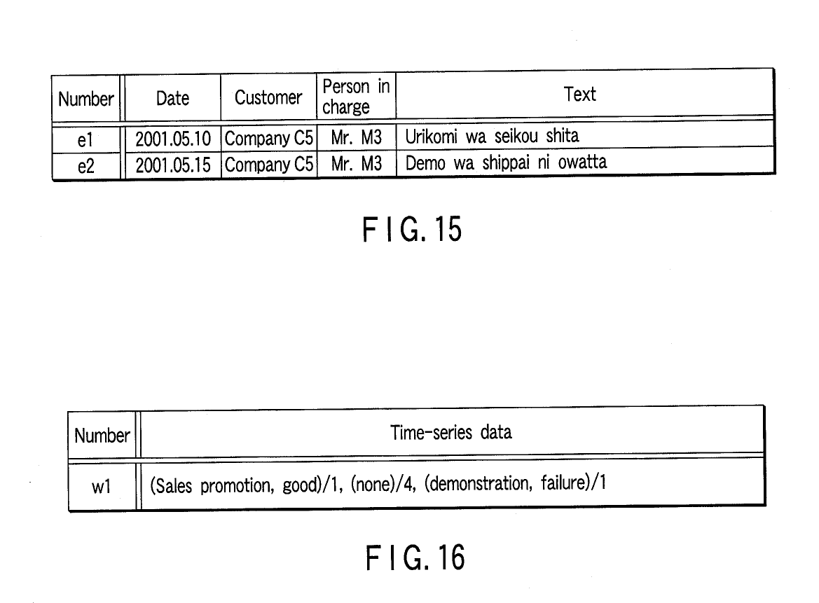

FIG. 14 shows an example of the procedure executed by this sequence text data analyzer apparatus. Assume that the model shown in FIG. 12 is obtained by processing similar to that described in the first embodiment and stored in the concept sequence model storage device 7. Assume also that the associated documents shown in FIG. 15 have been provided to the document storage device 1 as a sequence of new documents (to be evaluated) on which prediction is based. Note that e1 and e2 are the serial numbers of documents to be evaluated.

In step S21, the concept extractor 3 sorts the associated documents to be evaluated in chronological order according to time data attached to each document. In the case shown in FIG. 15, since the documents have already been provided in chronological order, no operation is done in this step.

In step S22, the concept extractor 3 extracts one document from the associated documents to be evaluated. If there is no document to be extracted, the flow advances to step S25. If there is a document to be extracted, the flow advances to step S23.

In step S23, the concept extractor 3 performs processing similar to that in step S15 in the procedure shown in FIG. 2 to generate a lexicon set corresponding to the document.

In step S24, the concept extractor 3 performs processing similar to that in step S16 in the procedure shown in FIG. 2 to extract a characteristic corresponding to the document. The flow then returns to step S22.

In step S25, the concept sequence generator 5 (and document time extractor 4) performs processing similar to that in step S17 in the procedure shown in FIG. 2 to generate time-series data from the characteristic and time corresponding to the document. In step S17 in FIG. 2, the chronologically last document is not processed. In step S25, however, even the last document is processed. In this case, therefore, the time-series data shown in FIG. 16 is generated for the associated documents in FIG. 15. Note that x1 is the serial number of time-series data generated from the documents to be evaluated.

In step S26, the concept sequence predicting device 8 makes an inference on the basis of the self-organized model (see FIG. 12) stored in the concept sequence model storage device 7 and the time-series data (see FIG. 16) obtained in step S25. This inference may be made in accordance with the extended object automaton inference method disclosed in the reference 2. In this method, by applying each time-series data to the model one by one, the time-series data held by each node and an evaluation value corresponding to the time-series data are updated. Assume that the time-series data shown in FIG. 16 are sequentially applied to the model in FIG. 12. In this case, when all the time-series data are applied, the time-series data are propagated to a node Na6, and the resultant evaluation value becomes 1.0 (maximum value).

In step S27, the concept sequence predicting device 8 applies special data containing no time-series data to the model to advance the time in the model in accordance with the extended object automaton inference method. At the terminal node, the attained time-series data and evaluation value are evaluated. If the evaluation value is high, a response corresponding to the terminal node is output. In addition, the concept sequence predicting device 8 predicts a situation that tends to occur by observing how responses are output. If, for example, all the time-series data shown in FIG. 16 are applied to the model in FIG. 12 to advance the time, the time-series data reach all the terminal nodes Nb1 to Nb3. At this time, the time-series data reaches the terminal node Nb2 earlier than the data reaching the terminal nodes Nb1 and Nb3. Obviously, in the current state, therefore, “order not received” is reached with higher possibility. As a consequence, these prediction results can be presented to the user.

In the above prediction, it is possible to present the user with a method of advancing in a desired or target direction as well as the possibility originated from the current time-series data. More specifically, in step S27, a method or condition for advancing in the desired direction can be presented to the user by retracing the time from a terminal node which provides a desired response.

In the above embodiments, assuming that a document is written in Japanese, the document is subjected to lexical analysis. If, however, a document is written in English, a characteristic can be extracted on the basis of the meanings of English words without performing lexical analysis.

Each function described above can be implemented as software.

In addition, the embodiments can be implemented as programs for causing a computer to execute predetermined means (or causing the computer to function as predetermined means or implement predetermined functions), and can be implemented as a computer-readable storage medium on which the programs are recorded.

Note that the arrangements exemplified in the embodiments of the present invention are merely examples and are not intended to exclude other arrangements. The present invention incorporates other arrangements that can be obtained by replacing part of the exemplified arrangement with another portion, omitting part of the exemplified arrangement, adding another function of element to the exemplified arrangement, or combining such replacement, omission, and addition. In addition, the present invention incorporates another arrangement logically equivalent to the exemplified arrangement, another arrangement including a portion logically equivalent to the exemplified arrangement, and another arrangement logically equivalent to the main part of the exemplified arrangement. Furthermore, the present invention incorporates another arrangement that achieves the same or similar object to that achieved by the exemplified arrangement, another arrangement that has the same or similar effect to that of the exemplified arrangement, and the like.

According to the present invention, a word (concept) sequence model serving as the basis for modeling regularity can be generated from a stored set of documents containing text data and time data.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A data analyzer apparatus comprising:
a document storage device configured to store a set of documents containing plural attributes representing at least text data and time data;
a key concept dictionary storage device configured to store a key concept dictionary including representative words or phrases that are likely to be described in the text data;
a selector configured to select a subset including plural documents associated with each other from the set of documents stored in the document storage device in accordance with a given combination of the attributes;
a first extraction device configured to extract a set of key concepts from each of plural documents belonging to the subset selected, based on the key concept dictionary;
a second extraction device configured to extract the time data from each of the plural documents belonging to the subset selected; and
a concept sequence generator configured to generate concept sequence including key concepts extracted from each of the documents belonging to the subset using the time data included in each of the documents.

2. A data analyzer apparatus according to claim 1, wherein the key concept dictionary includes information indicating correspondence of expression with the key concept, and the first extraction device subjects the document to a lexical analysis to obtain a lexical analysis result of the document and extracts the key concept corresponding to the expression by comparing the expression of the key concept dictionary with the lexical analysis result of the document.

3. A data analyzer apparatus according to claim 1, wherein the selector selects a subset of documents associated with each other from the set of documents stored in the document storage device, based on one or more attributes except for the time data.

4. A data analyzer apparatus according to claim 1, wherein the selector selects a subset of documents associated with each other from the set of documents stored in the document storage device, based on a result obtained by clustering one or all of the attributes.

5. A data analyzer apparatus according to claim 1, wherein the concept sequence generator saves the key concept extracted from the document having the latest time data in the subset based on the concept sequence, as a class corresponding to the concept sequence.

6. A data analyzer apparatus according to claim 1, wherein the time data represents date or date and time when the document is made.

7. A data analyzer apparatus according to claim 1, wherein the time data represents a date or a date and time related to contents of the text data included in the document.

8. A data analyzer apparatus according to claim 1, which further comprising a model generator configured to generate a model indicating a transition relation between at lease the key concepts, based on the plural concept sequence extracted from the plural documents,

9. A data analyzer apparatus according to claim 8, which further comprising a prediction device configured to extract at least one prediction key concept that is predicted to occur later than the time data of the concept sequence, by applying the model to the concept sequence generated from the plural documents to be predicted.

10. A data analyzer apparatus according to claim 9, wherein when the prediction device extracts plural prediction key concepts including a target key concept and key concepts except for the target key concept, the prediction device extracts a condition arriving at the target key concept.

11. A data analyzer apparatus comprising:
means for storing a set of documents containing plural attributes representing at least text data and time data and a key concept dictionary including representative words or phrases that are likely to be described in the text data;
means for selecting a subset including plural documents associated with each other from the set of documents stored in the storing means in accordance with a given combination of the attributes;
means for extracting a set of key concepts from each of plural documents belonging to the subset selected, based on the key concept dictionary, and extracting the time data from each of the plural documents belonging to the subset selected; and
means for generating concept sequence including key concepts extracted from each of the documents belonging to the subset using the time data included in each of the documents.

12. A data analysis method comprising:
storing a set of documents containing plural attributes representing at least text data and time data in a document storage device;
storing a key concept dictionary including representative words or phrases that are likely to be described in the text data in a key concept dictionary storage device;
selecting a subset including plural documents associated with each other from the set of documents stored in the document storage device in accordance with a given combination of the attributes;
extracting a set of key concepts from each of plural documents belonging to the subset selected, based on the key concept dictionary;
extracting the time data from each of the plural documents belonging to the subset selected; and
generating concept sequence including key concepts extracted from each of the documents belonging to the subset using the time data included in each of the documents.

13. A method according to claim 12, wherein the key concept dictionary includes information indicating correspondence of expression with the key concept, and extracting the set of key concepts includes subjecting the document to a lexical analysis to obtain a lexical analysis result of the document and extracting the key concept corresponding to the expression by comparing the expression of the key concept dictionary with the lexical analysis result of the document.

14. A method according to claim 12, wherein selecting the subset includes selecting a subset of documents associated with each other from the set of documents stored in the document storage device, based on one or more attributes except for the time data.

15. A method according to claim 12, wherein selecting the set of key concepts includes selecting a subset of documents associated with each other from the set of documents stored in the document storage device, based on a result obtained by clustering one or all of the attributes.

16. A method according to claim 12, wherein generating the concept sequence includes saving the key concept extracted from the document having the latest time data in the subset based on the concept sequence, as a class corresponding to the concept sequence.

17. A method according to claim 12, wherein the time data represents date or date and time when the document is made.

18. A method according to claim 12, wherein the time data represents a date or a date and time related to contents of the text data included in the document.

19. A method according to claim 12, further comprising generating a model indicating a transition relation between at lease the key concepts, based on the plural concept sequence extracted from the plural documents.

20. A method according to claim 19, further comprising extracting at least one prediction key concept that is predicted to occur later than the time data of the concept sequence, by applying the model to the concept sequence generated from the plural documents to be predicted.

21. A data analysis program stored in a computer readable medium, the program including:
means for instructing a computer to store a set of documents containing plural attributes representing at least text data and time data in a document storage device;
means for instructing the computer to store a key concept dictionary including representative words or phrases that are likely to be described in the text data in a key concept dictionary storage device;
means for instructing the computer to select a subset including plural documents associated with each other from the set of documents stored in the document storage device in accordance with a given combination of the attributes;
means for instructing the computer to extract a set of key concepts from each of plural documents belonging to the subset selected, based on the key concept dictionary;
means for instructing the computer to extract the time data from each of the plural documents belonging to the subset selected; and
means for instructing the computer to generate concept sequence including key concepts extracted from each of the documents belonging to the subset using the time data included in each of the documents.
